(19) United States
(12) Patent Application Publication
(10) Pub. No.: US 2004/0200508 A1
(43) Pub. Date: Oct. 14, 2004

(54) Dishwasher having air generator

(75) Inventors: Tae-Young Jung, Hwasung-City (KR); Woon-Gu Hur, Suwon-City (KR); Sam-Young Jang, Yongin-City (KR); Je-Hak Woo, Suwon-City (KR); Wang-Seok Son, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/689,507

(22) Filed: Oct. 21, 2003

(30) Foreign Application Priority Data
Nov. 1, 2002 (KR) 2002-67443
Mar. 28, 2003 (KR) 2003-19729

(51) Int. Cl. B08B 9/20

(52) U.S. Cl. 134/25.2; 134/57 D; 134/56 D; 134/58 D; 134/105; 134/186

(57) ABSTRACT

A dishwasher having an air generator is provided. In an operation of the dishwasher, air of a washing chamber is heated by a heater and, at a same time, water is fed into the washing chamber. Therefore, kitchen utensils and the water contained in the washing chamber are heated by heat exchanged from the heated air. Since the dishwasher primarily heats the air having a relatively lower specific heat and, thereafter, heats the water having a relatively higher specific heat by the heat of the heated air to produce hot water, the dishwasher reduces time consumption and improves an energy efficiency of the dishwasher during a dishwashing operation, and lengthens a life span of the heater.

### CROSS-REFERENCE TO RELATED APPLICATIONS

This application claims the benefit of Korean Application No. 2002-67443, filed on Nov. 1, 2002 and Korean Application No. 2003-19729, filed on Mar. 28, 2003, in the Korean Intellectual Property Office, the disclosure of which is incorporated herein by reference.

### BACKGROUND OF THE INVENTION

1. Field of the Invention

The present invention relates, in general, to dishwashers and, more particularly, to a dishwasher having a heater to heat washing water and rinsing water, and performing a washing operation, a rinsing operation and a drying operation.

2. Description of the Related Art

A dishwasher is a machine which washes kitchen utensils, such as dishes, bowls, etc., automatically, by spraying cold water or hot water onto the kitchen utensils held in racks installed in a washing chamber so as to remove food impurities from the kitchen utensils. The dishwasher is provided with a pump and a spray nozzle to feed and spray washing or rinsing water onto the kitchen utensils, and a heater to heat the washing or rinsing water so as to produce hot water. A conventional dishwasher will be described herein below with reference to FIG. 1.

FIG. 1 is a sectional view of a conventional dishwasher 102 having an internal heater. As shown in FIG. 1, the conventional dishwasher has a washing chamber 104 which is open at a front thereof. A door 106 is hinged to a front of a cabinet of the conventional dishwasher 102 so as to open or to close the open front of the washing chamber 104. Upper and lower racks 104a to support kitchen utensils therein are installed at respective upper and lower portions inside the washing chamber 104 such that the upper and lower racks 104a slide backward or forward when the upper and lower racks 104a are installed into or removed from the washing chamber 104. Upper and lower spray nozzles 104c are installed at a position under the upper and lower racks 104a, respectively, to spray water to the kitchen utensils held in the upper and lower racks 104a.

A heater 150 is installed on a bottom of the washing chamber 104 at a position under the lower rack 104a to directly heat washing or rinsing water to produce hot water. Since the heater 150 is installed inside the washing chamber 104, the heater 150 is a so-called “internal heater” in the following description. When the washing or rinsing water is fed into the washing chamber 104 such that the heater 150 is immersed in the washing or rinsing water, the washing or rinsing water is heated by the heater 150 to become the hot water. During a dishwashing operation, the hot water may easily remove impurities, such as food dregs, from the kitchen utensils. If the impurities, such as the food dregs, are dried and stuck on the kitchen utensils, the food impurities may be easily removed from the kitchen utensils when the kitchen utensils are immersed in the hot water for a time period to allow the food impurities to be sufficiently soaked in the hot water. During a rinsing operation, the hot water is used to heat the kitchen utensils. When the kitchen utensils are heated by the hot water at a last rinsing stage of the rinsing operation, moisture on the kitchen utensils more quickly evaporates from the kitchen utensils during a drying operation, due to latent heat of the kitchen utensils.

A water-collecting tank 108 is installed in a space defined in the washing chamber 104 at a position under the lower rack 104a, and collects the washing or rinsing water. A drain pump 110 and a water circulation pump 112 are connected to the water-collecting tank 108 via a drain hose 110a and a water circulation hose 112a, respectively. The water circulation hose 112a is further connected to a water feed pipe 104b which is connected to the upper and lower spray nozzles 104c.

During an operation of the conventional dishwasher 102, the washing or rinsing water is sprayed from the upper and lower spray nozzles 104c onto the kitchen utensils held in the upper and lower racks 104a so as to wash or to rinse the kitchen utensils, prior to being collected in the water-collecting tank 108. The washing or rinsing water is, thereafter, guided from the water-collecting tank 108 to the water feed pipe 104b through the water circulation hose 112a due to a pumping action of the water circulation pump 112, thus being fed to the upper and lower spray nozzles 104c and sprayed again from the upper and lower spray nozzles 104c. That is, the washing or rinsing water continuously circulates in the washing chamber 104 for a predetermined washing or rinsing time period. When the predetermined washing or rinsing time period is completed, the washing or rinsing water is drained from the water-collecting tank 108 through the drain hose 110a, due to a pumping action of the drain pump 110.

However, the conventional dishwasher having the internal heater is problematic as follows. Since the heater must be immersed in the washing or rinsing water to produce hot water during operations of the dishwasher, calcites are deposited on a surface of the heater, thus reducing the life span of the heater. Further, the heater of the conventional dishwasher directly heats the washing or rinsing water, so that excessive time is consumed to produce the hot water. The heater heats air of the washing chamber during a drying operation of the conventional dishwasher. In such a case, the kitchen utensils held in the upper and lower racks inside the washing chamber are excessively heated, so that a user cannot remove the kitchen utensils from the conventional dishwasher just after the drying operation.

In some models of conventional dishwashers, the water feed pipe is installed at a position outside the washing chamber and is connected to the spray nozzles provided in the washing chamber, with the heater installed inside the water feed pipe so as to heat the water passing through the water feed pipe and supply the heated water to the spray nozzles. Such a dishwasher is a so-called “dishwasher having external heater” in the following description. The dishwasher having the external heater is also problematic in that the heater must be immersed in the water to produce hot water during operations of the dishwasher, so that calcites are deposited on a surface of the heater and the life span of the heater is reduced, in a common manner as that described for the dishwashers having the internal heaters. Further, the dishwasher having the external heater directly heats the water by the heater, thus consuming excessive time and power during a dishwashing operation. To prevent the kitchen utensils from being excessively heated during a drying operation of the dishwasher having the external heater, the dishwasher rinses the kitchen utensils by use of the heated water at a last rinsing stage of a rinsing operation, in place of heating air of the washing chamber. The dishwasher having the external heater heats the kitchen utensils to an appropriate temperature during the rinsing operation, and quickly dries the kitchen utensils due to the latent heat of the heated kitchen utensils during the drying operation. However, the kitchen utensils must be rinsed by using the heated water at the last rinsing stage of the rinsing operation just before the drying operation, so that a drying operation without using water in the dishwasher having the external heater is not possible. Further, the rinsing of the kitchen utensils using the hot water must be performed just before the drying operation, thus consuming excessive power and reducing an energy efficiency of the dishwasher.

### SUMMARY OF THE INVENTION

Accordingly, it is an aspect of the present invention to provide a dishwasher having an air generator, which primarily heats chamber air having a relatively lower specific heat by use of a heater and, thereafter, heats water having a relatively higher specific heat by use of heat of the heated chamber air to produce hot water, thus reducing time, reducing consumption and improving energy efficiency during a dishwashing operation, and lengthening a life span of the heater.

Additional aspects and/or advantages of the invention will be set forth in part in the description which follows and, in part, will be obvious from the description, or may be learned by practice of the invention.

The above and/or other aspects are achieved by providing a dishwasher including an air generator to heat air in a washing chamber while circulating the heated air of the washing chamber. The air generator includes a blowpipe to circulate the air of the washing chamber, and a heater provided in the blowpipe to heat the air that is circulated through the blowpipe.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a sectional view of a conventional dishwasher;

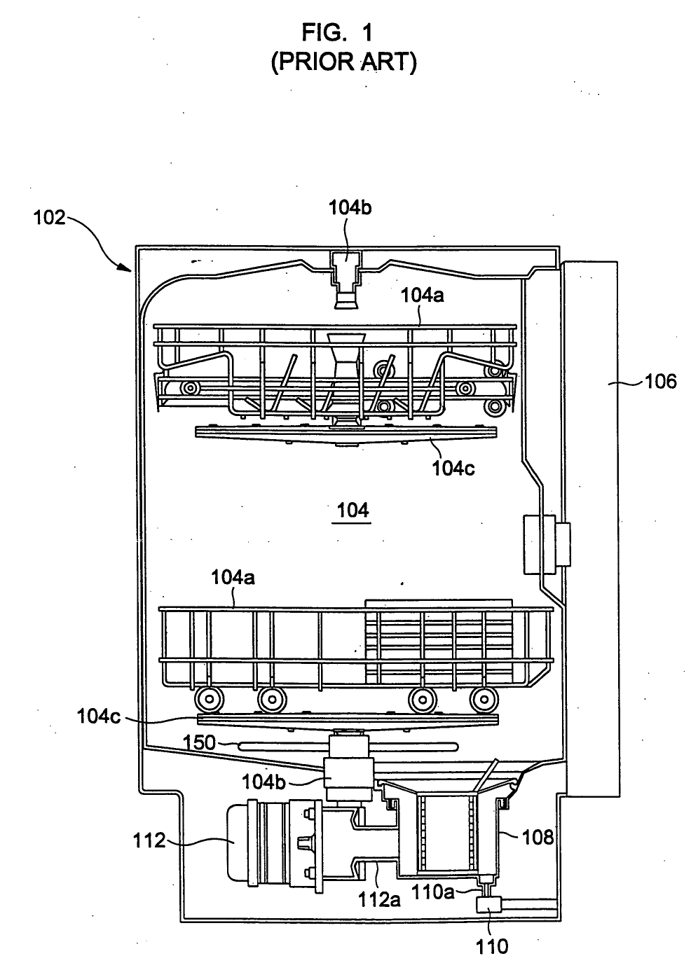

FIG. 2A is a sectional view of a dishwasher having an air generator, according to a first embodiment of the present invention;

FIG. 2B is a block diagram showing a construction of the dishwasher of FIG. 2A;

FIG. 3 is a sectional view of a dishwasher having an air generator, according to a second embodiment of the present invention;

FIG. 4 is a front view of the air generator included in the dishwasher of FIG. 3; and

FIG. 5 is a rear view of the air generator of FIG. 4.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

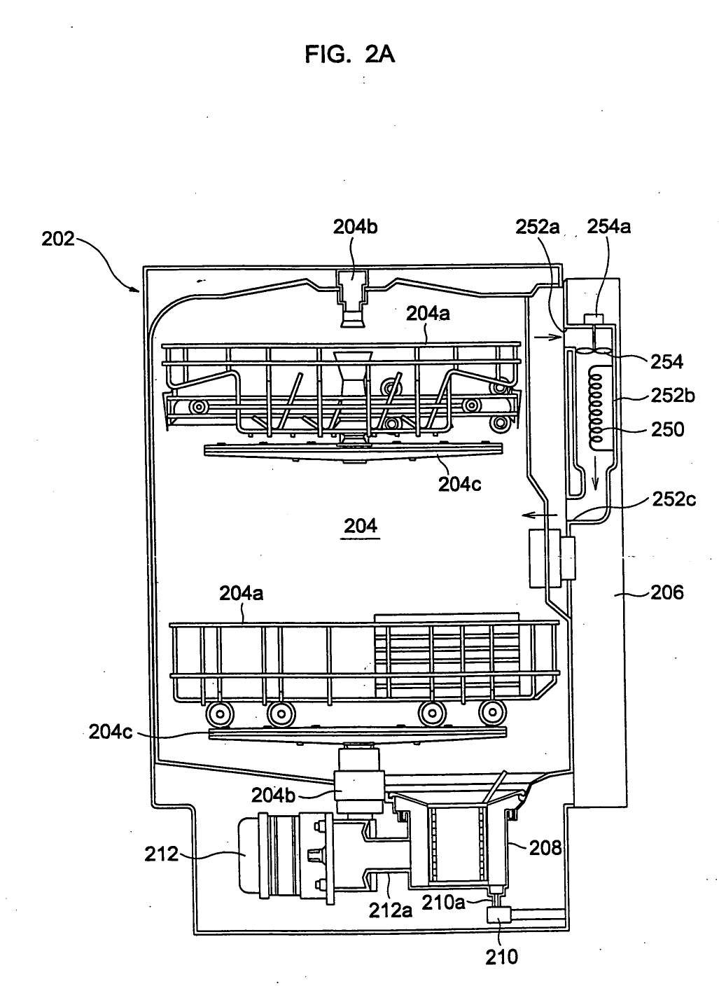

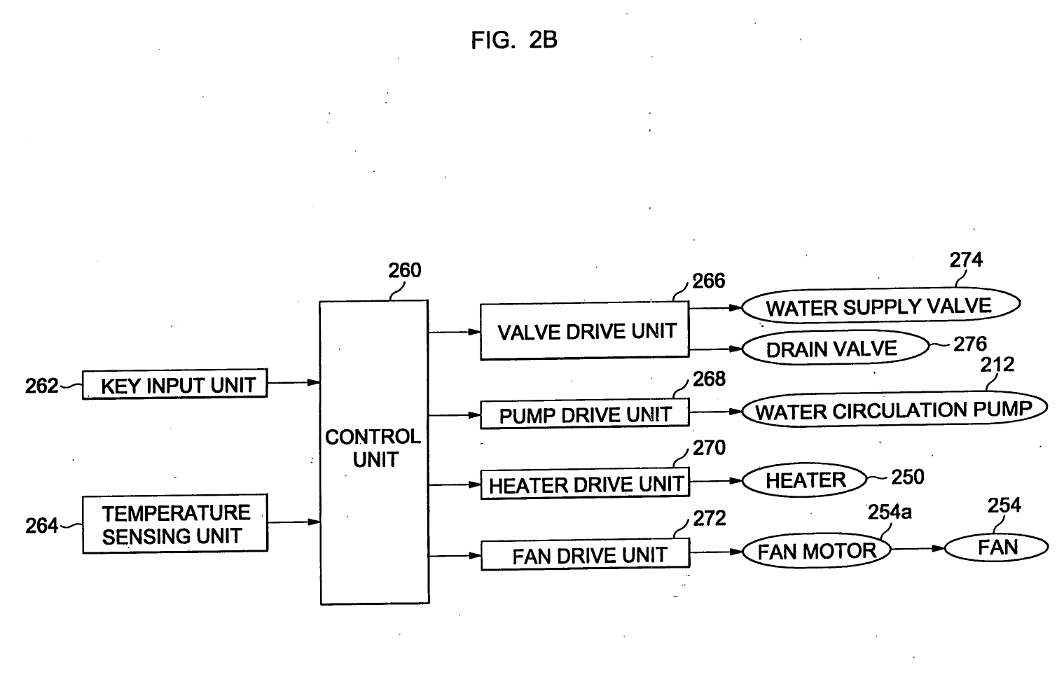

FIG. 2A is a sectional view of a dishwasher having an air generator, according to a first embodiment of the present invention. As shown in FIG. 2A, the dishwasher 202 according to an embodiment of the present invention has a cabinet, with a washing chamber 204 formed in the cabinet, and open at a front thereof. A door 206 is hinged to a front of the cabinet so as to open or to close the open front of the washing chamber 204. Upper and lower racks 204a to support kitchen utensils therein are installed at upper and lower portions, respectively, inside the washing chamber 204 such that the upper and lower racks 204a slide backward or forward. The upper and lower racks 204a are installed into or removable from the washing chamber 204. Upper and lower spray nozzles 204c are installed at positions under the upper and lower racks 204a, respectively, to spray water onto the kitchen utensils held in the upper and lower racks 204a. Further, a water-collecting tank 208 is installed in a space defined in the washing chamber 204 at a position under the lower rack 204a, and collects the washing or rinsing water. A drain pump 210 and a water circulation pump 212 are connected to the water-collecting tank 208 via a drain hose 210a and a water circulation hose 212a, respectively. The water circulation hose 212a is further connected to a water feed pipe 204b which is connected to the upper and lower spray nozzles 204c.

During an operation of the conventional dishwasher 102, the washing or rinsing water, sprayed from the upper and lower spray nozzles 204c onto the kitchen utensils held in the upper and lower racks 204a, is collected in the water-collecting tank 208, and is guided to the water feed pipe 204b through the water circulation hose 212a due to a pumping action of the water circulation pump 212. The water is, thereafter, fed to the upper and lower spray nozzles 204c so as to be sprayed again from the upper and lower spray nozzles 204c. Thus, the washing or rinsing water continuously circulates in the washing chamber 204 for a predetermined washing or rinsing time period. When the predetermined washing or rinsing time period is completed, the washing or rinsing water is drained from the water-collecting tank 208 through the drain hose 210a, due to a pumping action of the drain pump 210.

The dishwasher 202 has an air generator to heat air supplying the washing chamber 204 while circulating the heated air. The air generator includes the heater 250 and the fan 254. The door 206 is provided at a surface thereof facing the washing chamber 204 with an air inlet port 252a and a blast port 252c. The air inlet port 252a and the blast port 252c communicate with each other through a blowpipe 252b. The fan 254, rotating by a fan motor 254a, is provided at an end of the blowpipe 252b facing the air inlet port 252a, while the heater 250 is provided in an intermediate portion of the blowpipe 252b to heat the air passing therethrough. When the fan 254 rotates, the air is sucked from the washing chamber 204 into the blowpipe 252b through the air inlet port 252a. The sucked air is heated by the heater 250, and is discharged into the washing chamber 204 through the blast port 252c, thus being circulated in the washing chamber 204.

In the dishwasher 202, the heater 250 and the fan 254 are not limited in the positions thereof to an interior of the door 206. The heater 250 and the fan 254 may be installed at desired positions in or around the dishwasher 202, instead of in the door 206, without affecting an operation of the present invention. As a further alternative, the heater 250 and the fan 254 may be installed in a casing that is installed outside the cabinet of the dishwasher 202.

Further, two air blast ports may be formed on the door 206 at positions facing the washing chamber 204 and the outside of the cabinet, respectively, so that the air of the washing chamber 204 and atmospheric air are sucked into the blowpipe 252b through the two air blast ports, at a same time, to produce mixed air. In such a case, the mixed air of the chamber air and the atmospheric air is heated by the heater, prior to discharge into the washing chamber 204. As a further alternative, an air blast port may be formed at a position facing the outside of the cabinet, so that only the atmospheric air is sucked into the blowpipe 252b through the air blast port to be heated by the heater, prior to discharge into the washing chamber 204.

FIG. 2B is a block diagram showing a construction of the dishwasher 202 of FIG. 2A. As shown in FIG. 2B, the dishwasher 202 has a control unit 260 to control an operation of the dishwasher 202. The control unit 260 is connected at input terminals thereof to a key input unit 262 and a temperature sensing unit 264. The key input unit 262 allows a user to set desired operational conditions of the dishwasher 202, while the temperature sensing unit 264 senses a temperature of the air of the washing chamber 204.

The control unit 260 is connected at output terminals thereof to a valve drive unit 266, a pump drive unit 268, a heater drive unit 270, and a fan drive unit 272. The valve drive unit 266 operates a water supply valve 274 and a drain valve 276, while the pump drive unit 268 and the heater drive unit 270 operate the water circulation pump 212 and the heater 250, respectively. The fan drive unit 272 operates the fan motor 254a to rotate the fan 254. In such a case, the above-mentioned drive units 266, 268, 270 and 272 operate in response to control signals output from the control unit 260.

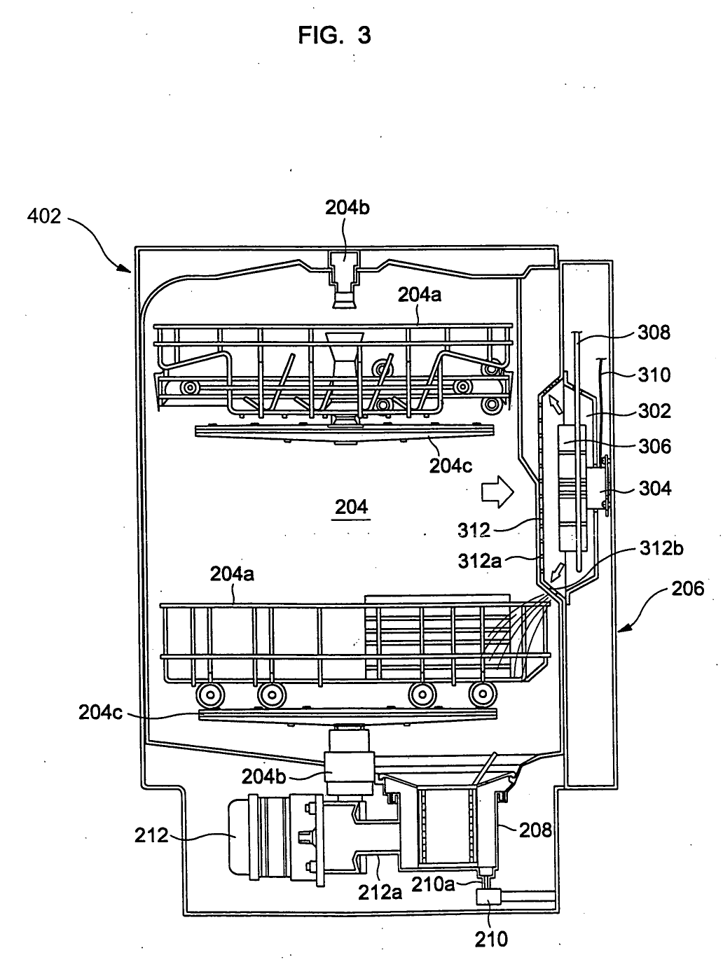

FIG. 3 is a sectional view of a dishwasher 402 having an air generator, according to a second embodiment of the present invention. As shown in FIG. 3, the dishwasher 402 according to the second embodiment has a casing 302 in the door 206. The casing 302 defines a space therein, with an opening formed at a surface of the casing 302. A fan 306, a heater 308 and a fan motor 304 are provided in the casing 302. When the heater 308 is electrically turned on to generate heat, air around the heater 308 in the casing 302 is heated. The heated air is discharged from the casing 302 into the washing chamber 204 by a blowing force of the fan 306. A part of the fan motor 304 projects from the casing 302 to mount to an inner surface of the door 206. It should be understood that the fan motor 304 may be mounted to an inner surface of the casing 302, without affecting an operation of the present invention.

A plate 312 having a plurality of vent holes 312a is installed at the opening of the casing 302, so that the air flows between an interior of the washing chamber 204 and the space of the casing 302 through the plurality of vent holes 312a. Further, a part of the water fed into the washing chamber 204 flows into the space of the casing 302 through the vent holes 312a, thus being heated. The heated water discharges from the casing 302 into the washing chamber 204 through a water discharging port 312b provided at a lower portion of the plate 312. When the air generator is turned on and, at a same time, the water is fed into the washing chamber 204 of the dishwasher 402 of FIG. 3, the air and the water supplied from the washing chamber 204 are heated at the same time.

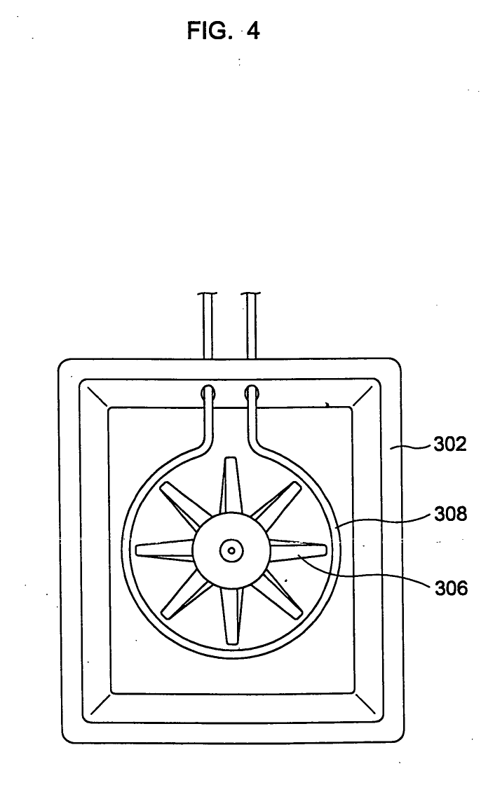

FIG. 4 is a front view of the air generator included in the dishwasher 402 of FIG. 3. As shown in FIG. 4, the fan 306 is rotatably mounted at a center of the space inside the casing 302, and the heater 308 is installed to surround the fan 306. The fan 306 may be a centrifugal impeller which causes the air to flow in a direction perpendicular to a rotating axis of the impeller. In such a case, the casing 302 is installed such that the opening of the casing 302 faces the washing chamber 204, and the fan 306 is installed in the casing 302 such that a rotating plane of the fan 306 faces the washing chamber 204. An electric wire (not shown) may be connected to each end of the heater 308 so as to supply electric power to the heater 308. The air heated by the heater 308 discharges from the casing 302 into the washing chamber 204 through the opening of the casing 302 due to the blowing force of the fan 306.

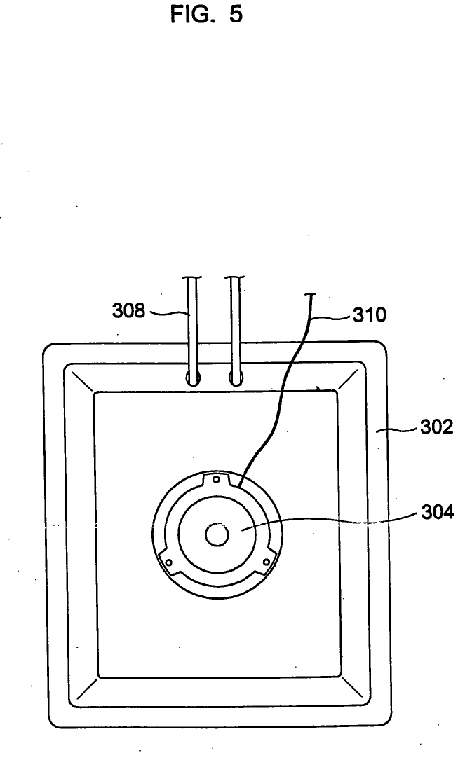

FIG. 5 is a rear view of the air generator of FIG. 4. As shown in FIG. 5, a part of the fan motor 304 projects from the rear wall of the casing 302 so as to be mounted to an inner surface of the door 206. An electric wire 310 is connected to the fan motor 304 to supply electric power to the fan motor 304.

During a washing operation of the dishwasher 402, the air of the washing chamber 204 is heated and, at the same time, the washing water is fed into the washing chamber 204, so that the kitchen utensils and the washing water inside the washing chamber 204 are heated by the heated air. In such a case, the air of the washing chamber 204 is continuously circulated while the air generator operates until a temperature of the air reaches a preset reference temperature. As the air of the washing chamber 204 is heated, the kitchen utensils held in the washing chamber 204 are heated. As the kitchen utensils are heated as described above, oil or other oily food impurities adhering to the kitchen utensils melt, so that the dishwashing effect is enhanced and the dishwashing time is remarkably reduced.

In an operation of the dishwasher 202 or 402, air having a relatively lower specific heat is primarily heated so that a temperature in a washing chamber 204 is quickly increased to a desired level within a short period of time, and, thereafter, water having a relatively higher specific heat is fed into the washing chamber 204 so that the water is heated by the heat of the heated air to produce hot water. The dishwasher 202 or 402 reduces time consumption and improves an energy efficiency during the dishwashing operation, in comparison with conventional dishwashers which directly heat the water. Further, kitchen utensils held in the upper and lower racks 204c installed in the washing chamber 204 are primarily heated to melt oil or other oily food impurities adhering to the kitchen utensils and, thereafter, the hot water is fed into the washing chamber 204 to wash the kitchen utensils. The dishwasher 204 or 402 further reduces time consumption and improves a dishwashing effect during the dishwashing operation. In the dishwasher 202 or 402, the water may be fed into the washing chamber 204 at the same time of heating the air of the washing chamber 204 in an effort to prevent the food impurities from being dried and stuck on the kitchen utensils.

As is apparent from the above description, a dishwasher having an air generator is provided. In an operation of the dishwasher, air having a relatively lower specific heat is primarily heated and, thereafter, kitchen utensils and washing or rinsing water having a relatively higher specific heat are heated by heat of the heated air. The dishwasher reduces time consumption during the dishwashing operation, in comparison with conventional dishwashers which directly heat the water. In the dishwasher, a drying operation is independently performed without necessarily following a hot water rinsing operation, thus improving an energy efficiency of the dishwasher 202 or 402. Further, since a heater of the dishwasher is not immersed in the water, calcites are not deposited on a surface of the heater, so that the life span of the heater is remarkably lengthened.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A dishwasher having a washing chamber, comprising:
an air generator to heat air of the washing chamber.

2. The dishwasher according to claim 1, wherein the air generator comprises:
a heater to heat the air of the washing chamber.

3. The dishwasher according to claim 2, wherein the heater is not immersed in water fed into the washing chamber.

4. The dishwasher according to claim 1, wherein the air generator further comprises:
a fan to circulate the air flowing around the heater.

5. The dishwasher according to claim 1, wherein the air generator comprises:
a blowpipe;
a fan provided at an open end of the blowpipe to circulate the air from the blowpipe into the washing chamber; and
a heater provided in the blowpipe to heat the air flowing through the blowpipe.

6. The dishwasher according to claim 5, further comprising:
a door to open or to close the washing chamber,
wherein the heater and the fan are provided in the door, to heat and circulate the air of the washing chamber.

7. The dishwasher according to claim 6, further comprising:
an air inlet port disposed with the door; and
a blast port at a surface of the door facing the washing chamber, the air inlet port and the blast port communicating with each other through the blowpipe.

8. The dishwasher according to claim 6, wherein the heater is provided at an intermediate position inside the blowpipe.

9. The dishwasher according to claim 5, further comprising:
a cabinet to define an external appearance of the dishwasher,
wherein the heater and the fan are provided in the cabinet.

10. The dishwasher according to claim 5, wherein the blowpipe comprises:
an air inlet port provided at a position facing the washing chamber or facing an outside of the dishwasher; and
a blast port provided at a position facing the washing chamber,
wherein the air inlet port and the blast port communicate with each other through the blowpipe.

11. The dishwasher according to claim 10, wherein the fan sucks atmospheric air into the washing chamber or circulates the air of the washing chamber.

12. The dishwasher according to claim 1, wherein the air generator comprises:
a casing to define a space therein, with an opening formed at a surface of the casing;
a fan provided in the casing to cause the air to circulate through the opening of the casing; and
a heater provided at a position around the fan to heat the air flowing around the fan.

13. The dishwasher according to claim 12, wherein the fan is a centrifugal impeller which causes the air to flow in a direction perpendicular to a rotating axis of the centrifugal impeller.

14. The dishwasher according to claim 12, wherein the opening of the casing faces the washing chamber, and the fan is provided in the casing such that a rotating plane of the fan faces the washing chamber.

15. The dishwasher according to claim 12, wherein the air generator further comprises:
a plate having a plurality of vent holes installed at the opening of the casing so that the air flows between an interior of the washing chamber and the space of the casing through a respective one of the plurality of vent holes of the plate.

16. The dishwasher according to claim 15, wherein a part of water fed into the washing chamber flows into the space of the casing through respective ones of the plurality of vent holes of the plate.

17. The dishwasher as set forth in claim 13, wherein a part of the fan projects from the casing to mount to an inner surface of the door.

18. The dishwasher as set forth in claim 15, wherein the plate comprises:
a water discharging port provided at a lower portion of the plate such that the heated water discharges from the casing into the washing chamber through the water discharging port.

19. The dishwasher as set forth in claim 18, wherein, when the air generator is turned on and the water is fed into the washing chamber, the air and the water are heated, simultaneously.

20. A dishwasher with a washing chamber, comprising:
an air generator heating and circulating air in the washing chamber.

21. The dishwasher as set forth in claim 20, wherein the air generator comprises:
a blowpipe circulating the air in the washing chamber; and
a heater disposed in the blowpipe to heat the air in the washing chamber circulated through the blowpipe.

22. The dishwasher as set forth in claim 20, wherein the air generator further comprises:
a fan to suck the air in the washing chamber to one side of the blowpipe.

23. The dishwasher as set forth in claim 20, further comprising:
an input unit to set a temperature of the air in the dishwasher,
a temperature detecting unit to detect the temperature of the air of the washing chamber; and
a control unit to control the detected temperature according to the set temperature.

24. The dishwasher as set forth in claim 20, wherein the air generator comprises:
a blowpipe;
a fan disposed at one opening of the blowpipe to circulate the air through the blowpipe and within the washing chamber; and
a heater disposed in the blowpipe to heat the air circulated through the blowpipe.

25. The dishwasher as set forth in claim 24, further comprising:
a door selectively closing the washing chamber, wherein the heater and the fan are disposed in the door to heat and to circulate air in the washing chamber, respectively.

26. The dishwasher as set forth in claim 25, wherein the door further comprises:
an air inlet and a blast port disposed in a surface of the door facing the washing chamber, and the air inlet and the blast port communicating with each other through the blowpipe.

27. The dishwasher as set forth in claim 21, wherein the heater is disposed in a middle portion of the blowpipe.

28. The dishwasher as set forth in claim 24, wherein the heater and the fan are disposed at positions outside of the washing chamber.

29. The dishwasher as set forth in claim 24, further comprising:
a cabinet defining an external appearance of the dishwasher, and
wherein the heater and the fan are disposed at positions inside of the cabinet of the dishwasher.

30. The dishwasher as set forth in claim 24, wherein the blowpipe comprises:
a first air inlet disposed facing one of the washing chamber and an outside of the dishwasher; and
a blast port disposed facing the washing chamber, the first air inlet communicating with the blast port through the blowpipe.

31. The dishwasher as set forth in claim 30, wherein the blowpipe comprises:
a second air inlet disposed facing another one of the washing chamber and an outside of the dishwasher such that the air from both the washing chamber and air from outside of the dishwasher are sucked into the first and second air inlets, respectively, and mixed in the blowpipe.

32. The dishwasher as set forth in claim 30, wherein the fan either sucks external air into the washing chamber or recirculates air from within the washing chamber.

33. The dishwasher as set forth in claim 24, wherein the heater is not immersed in the water supplied to the washing chamber.

34. A method of controlling a dishwasher having a washing chamber, comprising:
heating air supplied to the washing chamber; and
supplying water into the washing chamber and generating hot water through a heat exchange between the heated air and the supplied water.

35. The method as set forth in claim 34, further comprising:
circulating the air through a pipe and within the washing chamber, the heating of the air occurring as the air is circulated through the pipe.

36. The method as set forth in claim 34, further comprising:
drying the dishes by only the heated air from the heating of the air.

37. A method of controlling a dishwasher having a washing chamber, comprising:
heating air in the washing chamber;
supplying water into the washing chamber;
circulating the heated air such that a heat exchange between the heated air and the supplied water occurs; and
washing dishes using the heated water.

38. A dishwasher with a washing chamber, comprising:
an air generator heating air in the washing chamber to exchange heat between the heated air and water supplied to the washing chamber so as to heat the water supplied thereto, the air having a specific heat lower than that of the water.

39. A method of controlling a dishwasher having a washing chamber, comprising:
heating air supplied to the washing chamber;
supplying water into the washing chamber; and
circulating the heated air such that a heat exchange between the heated air and the supplied water occurs, the air having a specific heat lower than that of the water.

40. A method of controlling a dishwasher having a washing chamber, comprising:
heating air supplied to the washing chamber; and
drying dishes in the washing chamber by only using the heated air.

41. A method of controlling a dishwasher having a washing chamber, comprising:
heating air supplied to the washing chamber using a heater; and
supplying water into the washing chamber and generating hot water through a heat exchange between the heated air and the supplied water, wherein the heater is not submerged in the water supplied to the washing chamber.

42. A dishwasher with a washing chamber, comprising:
an air generator heating air in the washing chamber; and
a water supply unit supplying water into the washing chamber such that the air generator is not submerged in the water supplied to the washing chamber.

43. A method of controlling a dishwasher having a washing chamber, comprising:
heating air supplied to the washing chamber to indirectly heat water used during a dishwashing operation.
